(19) United States
(12) Patent Application Publication
(10) Pub. No.: US 2025/0269909 A1
(43) Pub. Date: Aug. 28, 2025

(54) VEHICLE SIDE STRUCTURE

(71) Applicants: Yukihiro HAMADA, Nisshin-shi Aichi-ken (JP); Akira MISHIMA, Ogaki-shi Gifu-ken (JP)

(72) Inventors: Yukihiro HAMADA, Nisshin-shi Aichi-ken (JP); Akira MISHIMA, Ogaki-shi Gifu-ken (JP)

(73) Assignees: TOYOTA JIDOSHA KABUSHIKI KAISHA, Toyota-shi Aichi-ken (JP); PACIFIC INDUSTRIAL CO., LTD., Ogaki Gifu (JP)

(21) Appl. No.: 19/062,754

(22) Filed: Feb. 25, 2025

(30) Foreign Application Priority Data
Feb. 28, 2024 (JP) 2024-029165

(51) Int. Cl. B62D 25/20

(52) U.S. Cl. CPC B62D 25/2036

(57) ABSTRACT

A vehicle side structure includes: a wheel arch portion placed at a rear side in relation to a side door opening, and having a suspension attachment portion; a side panel placed at an upper side of the wheel arch portion, that functions as a barrier separating an interior and an exterior of a vehicle; and an opening panel that covers a periphery of the side door opening from an outer side of a vehicle. The opening panel includes a first pillar which defines a rear end edge of the side door opening, and a rear end of the opening panel is positioned at a vehicle rear side in relation to the suspension attachment portion.

### CROSS REFERENCE TO RELATED APPLICATION

This application claims priority to Japanese Patent Application No. 2024-029165 filed on Feb. 28, 2024, which is incorporated herein by reference in its entirety including the specification, claims, drawings, and abstract.

### TECHNICAL FIELD

The present disclosure relates to a side structure of a vehicle.

### BACKGROUND

In general, a side door opening is formed on a side of a vehicle. A periphery of the side door opening is covered with a large-size panel member called an opening panel, from an outer side of the vehicle. In addition, at a vehicle rear side in relation to the side door opening, a wheel well which covers an upper part of a rear wheel is provided. For example, JP 2019-026239 A discloses a vehicle side structure having such an opening panel and a wheel well.

Normally, a suspension is attached to the wheel well. The suspension is a device which is interposed between a wheel and a vehicle body, and which reduces an impact from a road surface. In the suspension, a spring and a damper are provided. Because of this, a load from a road surface is absorbed by the suspension to a certain extent. However, it is difficult to completely absorb the load from the road surface with the suspension, and a part of the load is transferred from the wheel well to the vehicle body. In order to suppress deformation of a vehicle body, such a load from the road surface must be appropriately transferred to a rigid element, or must be distributed. However, in JP 2019-026239 A, insufficient consideration is given to a transfer route of the load from the road surface, and there remains room for improvement.

An aspect of the present disclosure lies in providing a vehicle side structure which can appropriately transfer the load from the road surface.

### SUMMARY

According to one aspect of the present disclosure, there is provided a vehicle side structure comprising: a wheel arch placed at a rear side in relation to a side door opening, and having a suspension attachment portion; a side panel placed at an upper side of the wheel arch, that functions as a barrier separating an interior and an exterior of a vehicle; and an opening panel that covers a periphery of the side door opening from an outer side of the vehicle, wherein the opening panel includes a first pillar which defines a rear end edge of the side door opening, and a rear end of the opening panel is positioned at a vehicle rear side in relation to the suspension attachment portion.

With the above-described structure, the load which is input from the suspension attachment portion is transferred to the opening panel. Because the opening panel has high rigidity, deformation of the vehicle body can be effectively prevented by transferring the load to the opening panel.

The vehicle side structure may further comprise: a second pillar that defines a boundary between a vehicle side surface and a vehicle back surface; and a strainer fixed on a surface of the side panel at an inner side of the vehicle, that extends from the suspension attachment portion to the second pillar.

By providing the strainer, a part of the load which is input from the suspension attachment portion can be transferred also to the strainer. As a result, deformation of the vehicle body can be more effectively prevented.

The vehicle side structure may further comprise a roof side rail that defines a boundary between the vehicle side surface and a vehicle roof, the rear end edge of the side door opening may have a bent portion which is bent to be convex toward the vehicle rear side, the opening panel may have a rear end edge which extends from the wheel arch in an approximate upward direction, which is bent in a forward-upward direction at a first height, and which extends to the roof side rail, the strainer may extend in an approximate upward direction from the suspension attachment portion toward the second pillar, the opening panel and the strainer may oppose each other in a vehicle width direction with the side panel therebetween in a range from the wheel arch up to the first height, and may extend in directions different from each other from the first height, and the first height may be positioned at a lower side than the bent portion.

With the structure described above, the load which is input from the suspension attachment portion can be transferred in a distributed manner in two directions; that is, in a direction toward the roof side rail and in a direction toward the second pillar. In addition, because a branch point of the load transfer route is at a lower level than the bent portion of the side door opening, the load reaching the bent portion can be reduced. As a result, deformation around the bent portion can be effectively suppressed.

The vehicle side structure may further comprise a kick-up component that is fixed on an upper surface of the wheel arch, and that overlaps the suspension attachment portion in an up-and-down direction, and the strainer may oppose a part of the kick-up component in the vehicle width direction with the side panel therebetween.

With the above-described structure, rigidity at the periphery of the suspension attachment portion can be improved, and deformation of the vehicle body can be more effectively prevented.

The vehicle side structure may further comprise a design panel made of a resin, that covers at least the side panel from an outer side, and that forms an exterior surface of the vehicle, and the opening panel may have fixing portions for the design panel, a door hinge, and a door lock.

By forming the outer surface of the vehicle with the design panel made of a resin, the vehicle can be reduced in weight. In addition, by placing fixing portions for a plurality of components on one component, the opening panel, precision for relative positions among the plurality of components can be maintained high.

According to a vehicle side structure of an aspect of the present disclosure, the load from the road surface can be appropriately transferred.

### BRIEF DESCRIPTION OF DRAWINGS

Embodiment(s) of the present disclosure will be described based on the following figures, wherein:

FIG. 1 is a perspective diagram of a vehicle rear portion;

FIG. 2 is a side view of the vehicle rear portion;

FIG. 3 is an enlarged view of a part A of FIG. 2;

FIG. 4 is a cross-sectional diagram along a line B-B of FIG. 1;

FIG. 5 is a cross-sectional diagram along a line C-C of FIG. 3; and

FIG. 6 is a cross-sectional diagram along a line D-D of FIG. 3.

### DESCRIPTION OF EMBODIMENTS

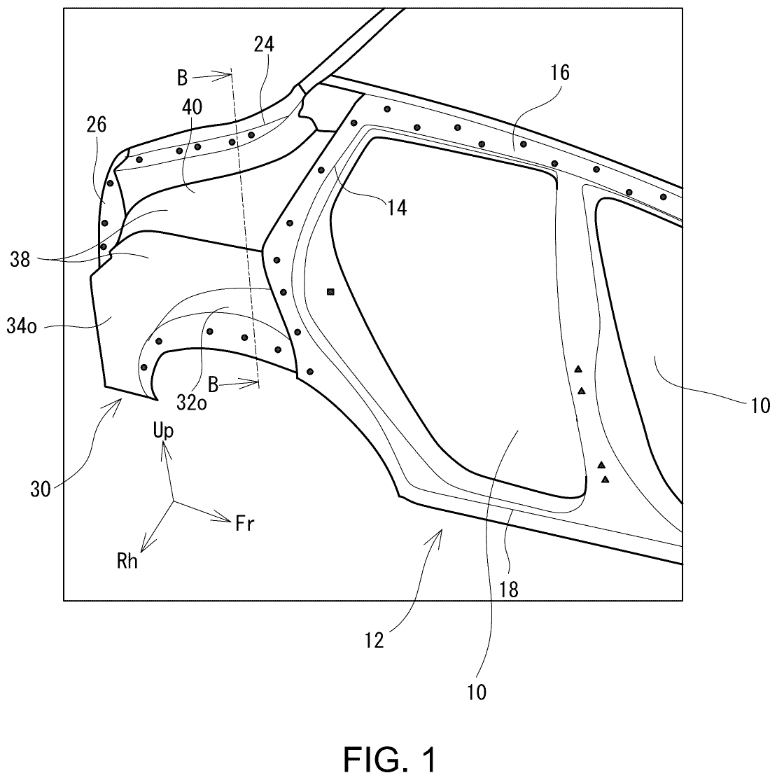

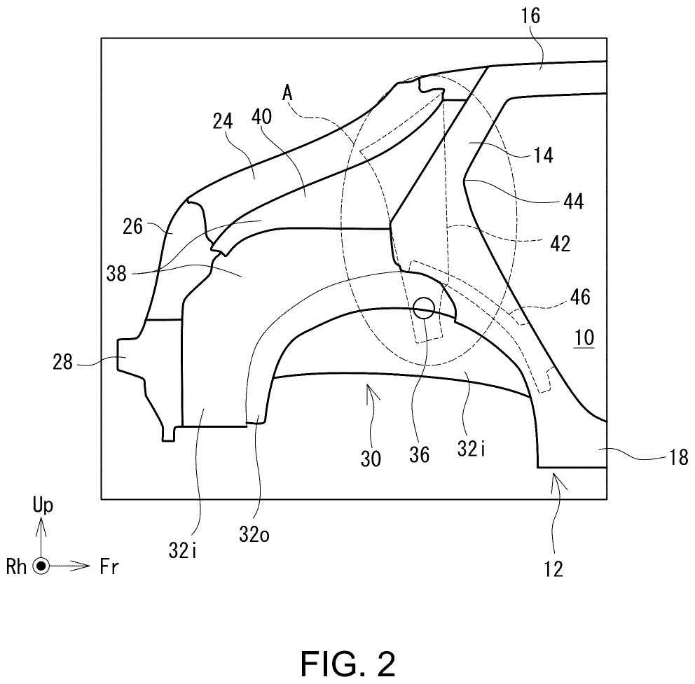

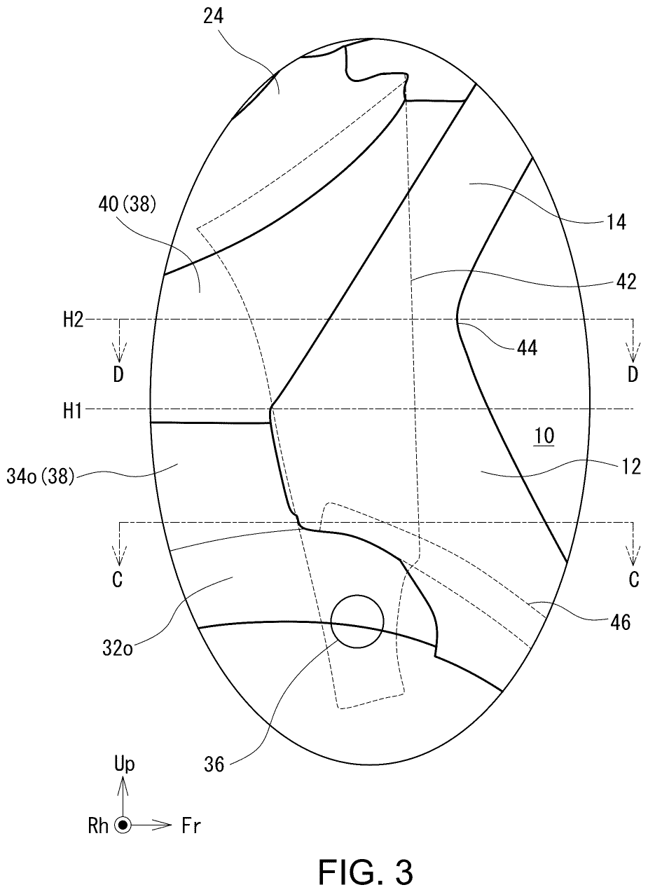

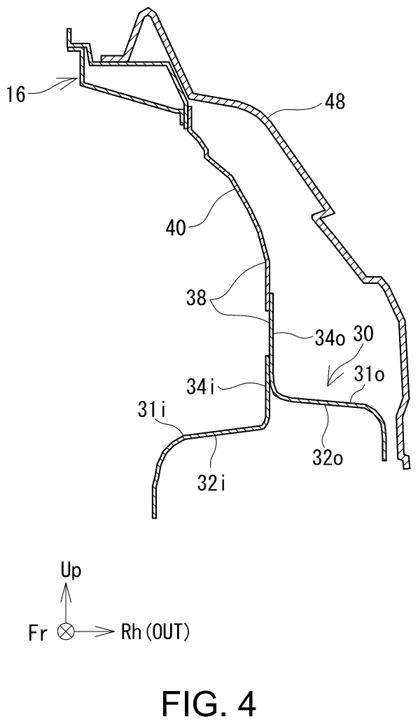

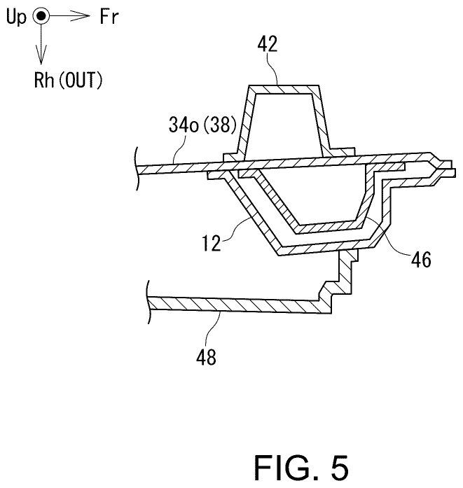

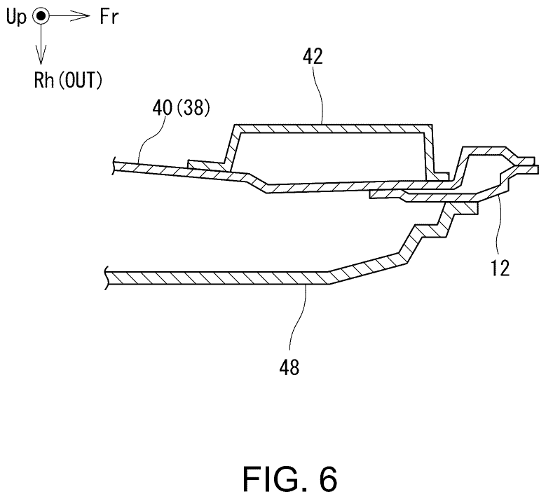

A vehicle side structure will now be described with reference to the drawings. FIG. 1 is a perspective diagram of a vehicle rear portion. FIG. 2 is a side view of the vehicle rear portion. FIG. 3 is an enlarged view of a part A of FIG. 2. FIG. 4 is a cross-sectional diagram along a line B-B of FIG. 1, and FIGS. 5 and 6 are respectively cross-sectional diagrams along a line C-C and a line D-D of FIG. 3. In the drawings, “Fr”, “Up”, and “Rh” respectively refer to a front side, an upper side, and a right side of the vehicle.

In a vehicle described below, an outer surface of the vehicle is formed from a design panel 48 made of a resin (refer to FIG. 4; a “resin design panel”), in place of a design panel made of a metal (metal design panel). That is, in the related art, the metal design panel called a “rear bumper panel”, a “quarter panel”, or a “rear fender panel” is attached on a side surface at a rear portion of the vehicle. In an embodiment of the present disclosure, in place of the metal design panel, the resin design panel 48 is employed. The resin design panel 48 will be described in detail later. In addition, in FIGS. 1 to 3, illustration of the resin design panel 48 is omitted.

As shown in FIG. 1, at a side of the vehicle, a side door opening 10 is formed. In the illustrated example configuration of FIG. 1, two side door openings 10 are formed, side by side in a front-and-rear direction. Alternatively, the technique of the present disclosure may be applied to a vehicle having one side door opening 10 at each of a left side and a right side. As shown in FIG. 3, a rear end edge of the side door opening 10 has a bent portion 44 which is convex toward a vehicle rear side, at a second height H2.

An opening panel 12 covers a periphery of the side door opening 10 from an outer side of the vehicle. The opening panel 12 is a large-size panel member molded in accordance with a shape of the side door opening 10. On the opening panel 12, fixing portions for the design panel 48, a door hinge (not shown), and a door lock (not shown) are provided. In FIG. 1, solid black circles show the fixing portions for the design panel 48. A solid black rectangle shows the fixing portion of the door hinge, and solid black triangles show the fixing portion for the door lock. In this manner, by providing the fixing portions for a plurality of components (the design panel 48, the door hinge, and the door lock) on one component, the opening panel 12, precision of the relative positions among the plurality of component is maintained high.

A part of the opening panel 12 functions as a first pillar 14, a roof side rail 16, and a rocker 18. The roof side rail 16 is a skeleton member which defines a boundary between a side surface of the vehicle and a roof. The rocker 18 is a skeleton member which defines a lower end of the side of the vehicle. Each of the roof side rail 16 and the rocker 18 is an approximate polygonal tubular member having a closed cross section, and is elongated in a vehicle front-and-rear direction.

The first pillar 14 is a skeleton member which extends downward from the roof side rail 16, and defines a rear end edge of the side door opening 10. As shown in FIGS. 5 and 6, the first pillar 14 forms a closed cross section with a side panel 38 to be described below.

As shown in FIGS. 1 and 2, a second pillar 24 is joined to a rear end of the roof side rail 16. The second pillar 24 is a skeleton member which defines a boundary between a back surface and a side surface of the vehicle. Similar to the first pillar 14, the second pillar 24 is an approximate polygonal tubular member having a closed cross section. A lower end of the second pillar 24 is connected to a rear end 28 via a lamp housing 26. The rear end 28 is a skeleton member which defines a lower end of the back surface of the vehicle. The rear end 28 is, for example, a polygonal tubular member elongated in the vehicle width direction. The lamp housing 26 is a member in which a rear lamp unit (not shown) is assembled. In the lamp housing 26, a recess for accommodating the rear lamp unit is formed.

At a rear side of the side door opening 10, a wheel well 30 is placed. As shown in FIG. 4, the wheel well 30 includes a wheel well outer portion 31o protruding toward an outer side in the vehicle width direction, and a wheel well inner portion 31i protruding toward an inner side in the vehicle width direction. The wheel well outer portion 31o and the wheel well inner portion 31i respectively have wheel arch portions 32o and 32i along a circumferential surface of a rear wheel (not shown), and flange portions 34o and 34i extending from the wheel arch portions 32o and 32i toward an outer side in a radial direction of the rear wheel. The wheel well 30 is formed by joining the flange portion 34i of the wheel well inner portion 31i to the flange portion 34o of the wheel well outer portion 31o.

As shown in FIG. 3, in the present embodiment, a roof side inner portion 40 to be described later is joined to the flange portion 34o of the wheel well outer portion 31o. However, alternatively, the roof side inner 40 may be joined to the flange portion 34i of the wheel well inner portion 31i, in place of the flange portion 34o of the wheel well outer portion 31o. In the following description, if either one of the flange portions 34o and 34i may be employed, the indices “i” and “o” will be omitted, and the flange portion will be simply called the “flange portion 34”. This is similarly applicable to the wheel arch portions 32o and 32i.

The side panel 38 which functions as a barrier separating the interior and the exterior of the vehicle is placed between the first pillar 14 and the second pillar 24. The side panel 38 may be a single panel member, or may be formed by combining a plurality of panel members. In the present embodiment, the side panel 38 includes the roof side inner portion 40 and the flange portion 34 of the wheel well 30. The roof side inner portion 40 is a panel member which fills an area surrounded by the first pillar 14, the flange portion 34, the lamp housing 26, and the second pillar 24, without a gap. A periphery of the roof side inner 40 is joined to other members such as the first pillar 14 over the entire periphery thereof.

A strainer 42 is fixed on a surface of the side panel 38 at an inner side of the vehicle. As shown in FIGS. 5 and 6, the strainer 42 has an approximate hat shape in cross section, and forms a closed cross section with the side panel 38. As shown in FIGS. 2 and 3 by dashed lines, the strainer 42 connects the wheel arch portion 32i and the second pillar 24. That is, the strainer 42 extends in a direction different from the first pillar 14, and functions as a skeleton member different from the first pillar 14. A region of the strainer 42 near a lower end opposes a part of the opening panel 12. This structure will be described later.

Further, as shown in FIG. 2 with a dashed line, a kick-up component 46 is placed near the wheel arch portion 32o. The kick-up component 46 is a component which reinforces a region around the wheel arch portion 32o. The kick-up component 46 has a shape along a circular arc of an upper surface of the wheel arch portion 32o. As shown in FIG. 5, the kick-up component 46 is fixed to a surface of the side panel 38 on the outer side of the vehicle. Because the kick-up component 46 is covered with the opening panel 12 from the outer side, the kick-up component 46 cannot be viewed from outside the vehicle.

As shown in FIGS. 4 to 6, the side panel 38 is covered with the design panel 48 from the outer side of the vehicle. The design panel 48 is a panel which forms an outer surface of the vehicle. In the present embodiment, the design panel 48 is formed from a resin. With the use of the resin design panel 48, various aspects can be obtained.

Specifically, in many of the vehicles of the related art, a design panel made of a metal called a “rear bumper panel” or a “quarter panel” is employed. However, a metal design panel is heavy, and has a low degree of freedom of molding. On the other hand, the resin design panel 48 is significantly lighter in comparison to the metal design panel. Further, when the resin design panel 48 is used, man-hours for painting can be reduced. With these characteristics, amount of discharged CO₂ can be reduced. In addition, because a resin has a higher degree of freedom of molding in comparison to a metal, the degree of freedom of the design of the vehicle can be improved by employing a resin as the material for the design panel 48. Moreover, because the resin design panel 48 is attached to a body of the vehicle by a fastening member such as a clip, the resin design panel 48 can be detached from and attached to the body of the vehicle. Thus, when the design panel 48 is made of a resin, the design of the vehicle can be more easily changed in comparison to the case of a metal panel. For example, when the resin design panel 48 is employed, an outer appearance of the vehicle can be “dressed up”.

On the other hand, when the resin design panel 48 is used, the design panel 48 and the skeleton member (for example, the first pillar 14, the second pillar 24, and the like) cannot be joined together, and it is difficult to liquid-tightly seal these members. In consideration of this, in the present embodiment, in order to prevent intrusion of raindrops into a vehicle cabin, the side panel 38 is liquid-tightly sealed with the peripheral skeleton members. More specifically, joining portions between the roof side inner 40 and the other members, and joining portions between the flange portion 34 and the other members are respectively liquid-tightly sealed. As a seal for this configuration, for example, a paint seal may be used.

In addition to the above, when the resin design panel 48 is used, the rigidity around the wheel well 30 is reduced in comparison to the case in which the metal design panel is used. In particular, there is a possibility that, due to the load transferred from the road surface to the vehicle body through the suspension (not shown), deformation of members around the wheel well 30 may be caused. In the present embodiment, in order to suppress such a deformation, a rear end of the opening panel 12 is positioned at a vehicle rear side in relation to a suspension attachment portion 36. This configuration will now be described in detail.

The wheel well 30 has the suspension attachment portion 36. As shown in FIGS. 2 and 3, the suspension attachment portion 36 is placed, for example, on the wheel arch portion 32i of the wheel well inner portion 30i. A tip of a shaft of the suspension (not shown) is attached to the suspension attachment portion 36.

A load of an impact from the road surface is absorbed with the suspension to a certain extent. However, it is difficult to absorb all of such a load with the suspension, and a part of the load is transferred to the vehicle body through the suspension attachment portion 36.

As described above, in the present embodiment, the rear end of the opening panel 12 is positioned at the vehicle rear side in relation to the suspension attachment portion 36. In other words, a front-and-rear direction range of the opening panel 12 overlaps a front-and-rear direction range of the suspension attachment portion 36. Because of this, the load which is input to the suspension attachment portion 36 is transferred to the first pillar 14 and the roof side rail 16 which are a part of the opening panel 12. Because the first pillar 14 and the roof side rail 16 are both skeleton members with high rigidity, these members can tolerate the load without being deformed. As a result, according to the present embodiment, deformation of the vehicle body can be effectively prevented.

As shown in FIGS. 2 and 3, a rear end edge of the opening panel 12 extends from the wheel arch portion 32 approximately upward, is bent in a forward-upward direction at a first height H1, and extends to the roof side rail 16. As shown in FIGS. 3 and 5, in a range from the wheel arch portion 32 to the first height H1, the opening panel 12 overlaps the strainer 42 in the vehicle width direction with the side panel 38 therebetween. With this configuration, the rigidity of the vehicle body around the suspension attachment portion 36 can be improved, and deformation of the vehicle body at a region around the suspension attachment portion 36 can be effectively prevented.

As shown in FIG. 3, the kick-up component 46 is placed near the suspension attachment portion 36. As shown in FIG. 5, the kick-up component 46 opposes the strainer 42 in the vehicle width direction with the side panel 38 therebetween. Further, the kick-up component 46 is housed in the closed cross section of the opening panel 12. With this configuration, the rigidity around the suspension attachment portion 36 is further improved, and deformation of the vehicle body can be more effectively prevented.

As shown in FIG. 3, with the first height H1 as a boundary, the opening panel 12 and the strainer 42 extend in directions different from each other. In other words, the directions of extension of the opening panel 12 and the strainer 42 are branched in the middle. In this case, a part of the load which is input from the suspension attachment portion 36 to the opening panel 12 and the strainer 42 is transferred to the roof side rail 16, and another part of the load is transferred to the second pillar 24. In other words, the load is distributed to two directions. As a result, concentration of the load is prevented, and deformation of the vehicle body can be more effectively prevented.

Moreover, as shown in FIG. 3, the rear end edge of the side door opening 10 has the bent portion 44 which is convex toward the vehicle rear side. Stress tends to concentrate at such a bent portion 44 of the opening. In the present embodiment, the opening panel 12 and the strainer 42 are branched at the first height H1 which is lower than the bent portion 44. As a result, the load which is input from the suspension attachment portion 36 to the vehicle body is distributed to two directions before reaching the bent portion 44. With this configuration, transfer of a large load to the periphery of the bent portion 44 is prevented, and deformation of the periphery of the bent portion 44 can be effectively prevented.

In addition, in the present embodiment, the first pillar 14 is connected to the roof side rail 16, and the strainer 42 is connected to the second pillar 24. Because of this, due to, for example, the vehicle rolling over on its side, a load is input from the roof of the vehicle toward a lower part of the vehicle, the load can be transferred to the first pillar 14 and the strainer 42. Here, the first pillar 14 and the strainer 42 are both skeleton members having closed cross sections, and are high-rigidity components. By transferring the load to such high-rigidity components, deformation of the vehicle body can be more effectively prevented even in the case of the roll-over of the vehicle.

As is clear from the above description, according to the present embodiment, the load transferred through the suspension attachment portion 36 to the vehicle body is transferred to the opening panel 12. As a result, deformation of the vehicle body can be more effectively prevented. The above-described structure is merely exemplary, and, so long as the vehicle side structure has the structure described in claim 1, the other structures may be suitably changed. For example, the strainer 42 and the kick-up component 46 may be omitted. In addition, the opening panel 12 may have other shapes, so long as the rear end of the opening panel 12 is positioned at the vehicle rear side in relation to the suspension attachment portion 36.

### REFERENCE SIGNS LIST

10 side door opening, 12 opening panel, 14 first pillar, 16 roof side rail, 18 rocker, 24 second pillar, 26 lamp housing, 28 rear end, 30 wheel well, 32 wheel arch portion, 34 flange portion, 36 suspension attachment portion, 38 side panel, 40 roof side inner, 42 strainer, 44 bent portion, 46 kick-up component, 48 design panel.

1. A vehicle side structure comprising:
a wheel arch placed at a rear side in relation to a side door opening, and having a suspension attachment portion;
a side panel placed at an upper side of the wheel arch, that functions as a barrier separating an interior and an exterior of a vehicle; and
an opening panel that covers a periphery of the side door opening from an outer side of the vehicle, wherein
the opening panel includes a first pillar which defines a rear end edge of the side door opening, and
a rear end of the opening panel is positioned at a vehicle rear side in relation to the suspension attachment portion.

2. The vehicle side structure according to claim 1, further comprising:
a second pillar that defines a boundary between a vehicle side surface and a vehicle back surface; and
a strainer fixed on a surface of the side panel at an inner side of the vehicle, that extends from the suspension attachment portion to the second pillar.

3. The vehicle side structure according to claim 2, further comprising:
a roof side rail that defines a boundary between the vehicle side surface and a vehicle roof, wherein
the rear end edge of the side door opening has a bent portion which is bent to be convex toward a vehicle rear side,
the opening panel has a rear end edge which extends from the wheel arch in an approximate upward direction, which is bent in a forward-upward direction at a first height, and which extends to the roof side rail,
the strainer extends in an approximate upward direction from the suspension attachment portion toward the second pillar,
the opening panel and the strainer oppose each other in a vehicle width direction with the side panel therebetween in a range from the wheel arch up to the first height, and extend in directions different from each other from the first height, and
the first height is positioned at a lower level than the bent portion.

4. The vehicle side structure according to claim 3, further comprising:
a kick-up component that is fixed on an upper surface of the wheel arch, that overlaps the suspension attachment portion in an up-and-down direction, wherein
the strainer opposes a part of the kick-up component in the vehicle width direction with the side panel therebetween.

5. The vehicle side structure according to claim 1, further comprising:
a design panel made of a resin, that covers at least the side panel from an outer side, and that forms an outer surface of the vehicle, and
the opening panel has fixing portions for the design panel, a door hinge, and a door lock.
